(19) United States
(12) Patent Application Publication
(10) Pub. No.: US 2020/0219638 A1
(43) Pub. Date: Jul. 9, 2020

(54) Cables Incorporating Asymmetrical Separators

(71) Applicant: Superior Essex International LP, Atlanta, GA (US)

(72) Inventor: Jeffery Scott Williams, Hoisington, KS (US)

(21) Appl. No.: 16/240,848

(22) Filed: Jan. 7, 2019

(51) Int. Cl. H01B 7/42; G02B 6/44; H01B 11/04; H01B 9/00

(52) U.S. Cl. CPC H01B 7/426; G02B 6/4416; H01B 7/423; H01B 9/005; H01B 11/04

(57) ABSTRACT

Cables incorporating a separator positioned between two or more subcomponents are described. A separator may extend in a longitudinal direction and include a body portion having an asymmetrical cross-sectional. Additionally, an outer periphery of the body portion may define a plurality of longitudinally extending channels including a first channel having a first cross-sectional area and a second channel having a second cross-sectional area different than the first cross-sectional area. At least one cavity may optionally extend through the body portion along the longitudinal direction. A first cable subcomponent including first transmission media may be positioned within the first channel, and a second cable subcomponent including second transmission media may be positioned within the second channel. A jacket may be formed around the separator and the subcomponents.

### TECHNICAL FIELD

Embodiments of the disclosure relate generally to cables and, more particularly, to cables that include separators have an asymmetrical cross-sectional shape that are positioned between a plurality of subcomponents.

### BACKGROUND

Cables are utilized in a wide variety of applications to transmit power and/or data signals. In certain applications, an overall cable may be formed from a bundle or combination of individual cable components. In many circumstances the components or sub-cables incorporated into a bundle may have different diameters or cross-sectional sizes. For example, a cable may include a combination of conductive components, such as twisted pair components and/or power conductors, that have different cross-sectional sizes. As another example, a hybrid cable may include a combination of conductive components and components containing other types of transmission media, such as optical fiber components, and the various components may have different cross-sectional sizes. The size variations of the different cable components often make it difficult to form an overall cable having a desired cross-sectional shape, such as a desired round cross-sectional shape. Accordingly, there is an opportunity for improved cables that include components having different cross-sectional sizes and a separators that facilitates the cable having a desired overall cross-sectional shape.

Additionally, cable components that include conductive elements, such as twisted pair components and/or power conductors, typically generate heat during operation. As one example, with a cable installed in a data center, portions of a cable situated in relatively close proximity to electronic equipment and/or equipment cabinets may become hotter than other portions of the cable. The heat may negatively impact both the electrical performance of the cable and the performance of electronic equipment associated with the cable. Cross-talk may also occur between certain components positioned within relatively close proximity to one another, such as twisted pair components. Accordingly, there is an opportunity for improved cables that provide for separation between cable components and heat transfer that assists in cooling a cable and/or any associated electronic equipment.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1 is a cross-sectional view of an example cable that include a plurality of components formed around an asymmetrical separator, according to an illustrative embodiment of the disclosure.

FIGS. 2A-3B are cross-sectional views of example separators that may be incorporated into cables, according to illustrative embodiments of the disclosure.

### DETAILED DESCRIPTION

Various embodiments of the present disclosure are directed to cables that include separators positioned between a plurality of cable subcomponents. A separator may be formed as a longitudinally extending filler or divider that is positioned between two or more of the plurality of cable subcomponents. In certain embodiments, a separator may be formed with an asymmetrical cross-sectional shape. In other words, the separator may have a shape or body portion that is asymmetrical along a line extending perpendicular to a longitudinally extending direction and that bisects the cable and/or the separator. Additionally, an outer surface of the separator may define a plurality of channels into which the plurality of cable subcomponents are positioned. In certain embodiments, at least two of the plurality of channels may have cross-sectional areas that are different from one another.

As a result of a separator including an asymmetrical cross-sectional shape and/or a separator defining at least two channels having different cross-sectional sizes, the separator may facilitate the formation of a cable that includes at least two subcomponents having different cross-sectional sizes while the cable also has a desired overall cross-sectional shape or profile. For example, a plurality of cable subcomponents having different cross-sectional sizes may be positioned into corresponding channels having different cross-sectional sizes and that are defined by an outer periphery of a separator. In certain embodiments, the separator channels may position the cable subcomponents such that the cable includes a round or circular cross-sectional shape or profile.

As desired, a separator may additionally include one or more longitudinally extending channels extending through a body portion of the separator and defining one or more internal cavities. In certain embodiments, these channels may facilitate cooling of one or more cable subcomponents. For example, heat generated in one or more cable subcomponents and/or associated equipment may be dissipated, transferred, and/or otherwise mitigated by the separator through the channel(s). As desired, cooling may be facilitated via convective heat transfer along a longitudinal length of a cable, via circulation of one or more fluids (e.g., one or more gases, one or more liquids, a refrigerant, etc.) through the channel(s) and/or via other suitable techniques. In certain embodiments, the cooling facilitated by the separator may result in improved cable performance (e.g., a higher power rating, etc.).

Any number of suitable cable subcomponents may be positioned adjacent to a separator. In certain embodiments, a number of cable subcomponents may correspond to a number of channels defined by or along an outer periphery of the separator. Further, a wide variety of different types of cable subcomponents may be positioned adjacent to the separator. Examples of suitable cable subcomponents include but are not limited to, twisted pair cable subcomponents, power cable subcomponents, optical fiber cable subcomponents, coaxial cable subcomponents, and/or hybrid cable subcomponents that include a plurality of different types of transmission media. As desired, the cable subcomponents may include jacketed subcomponents, subcomponents that include an outer wrap or binder, and/or unjacketed cable subcomponents. Additionally, in certain embodiments, at least two of a plurality of cable subcomponents positioned adjacent to a separator may be formed with different cross-sectional areas and/or diameters. A shape of the separator may facilitate incorporation of the plurality of cable subcomponents into a cable having a desired overall cross-sectional shape, such as a circular cross-sectional shape.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example Cable Construction

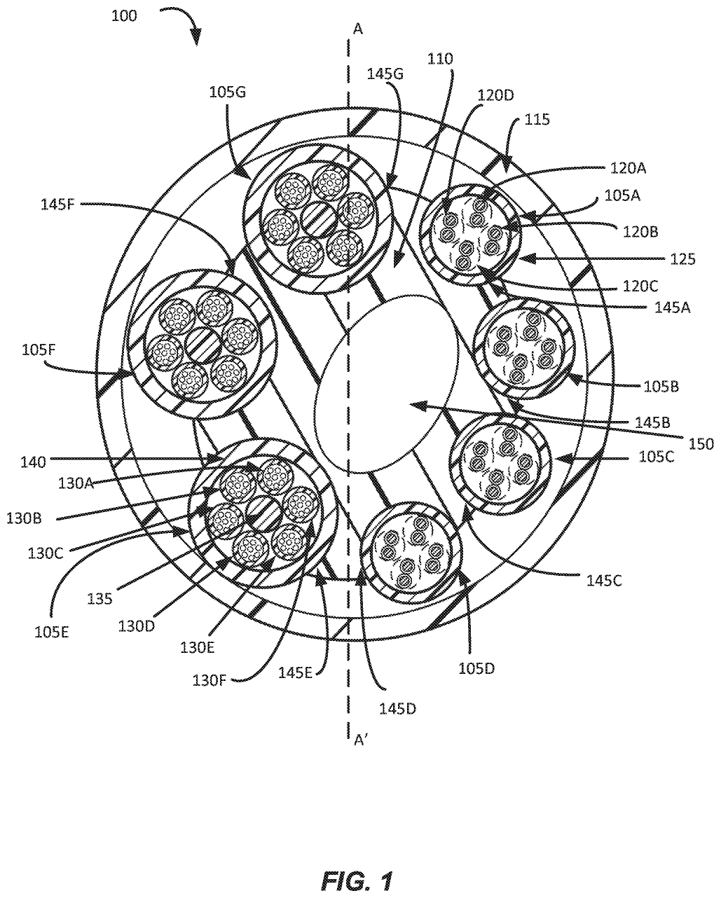

With reference to FIG. 1, a cross-section of an example cable 100 that may be utilized in various embodiments is illustrated. According to an aspect of the disclosure, the cable 100 may include a plurality of subcomponents or sub-cables 105A-G, and a separator 110 may be positioned between at least two of the subcomponents 105A-G. For example, the subcomponents 105A-G may be positioned around an outer periphery of the separator 110. The cable 100 is illustrated as a hybrid cable that includes a combination of twisted pair subcomponents 105A-D and optical fiber subcomponents 105E-G. However, the cable 100 may be formed with subcomponents that include any suitable transmission media and/or combinations of transmission media. Additionally, embodiments of the disclosure may be utilized in association with horizontal cables, vertical cables, flexible cables, equipment cords, plenum cables, riser cables, or any other appropriate cables. An outer jacket 115 may then be formed around the subcomponents 105A-G and the separator 110. Each of the components illustrated in FIG. 1 is described in greater detail below.

Any number of subcomponents, such as subcomponents 105A-G, may be incorporated into a cable 100 as desired in various embodiments. In various example embodiments, approximately 2, 3, 4, 5, 6, 7, 8, 9, 10, 11, or 12 subcomponents may be incorporated into a cable 100, a number of subcomponents may be included in a range between any two of the above values (e.g., between 2 and 10 subcomponents, etc.), or a number of subcomponents may be included in a range bounded on a minimum end by one of the above values (e.g., greater than 2 subcomponents, etc.). Additionally, in certain embodiments, a single ring or other suitable layer of subcomponents 110A-G may be incorporated into the cable 100 and positioned around the separator 110. In other embodiments, a first ring or layer of subcomponents 110A-G may be positioned around the separator 110 and one or more additional rings or layers of subcomponents may be formed around the first layer.

A subcomponent (generally referred to as subcomponent 105) may include any suitable types of transmission media and/or other components. In other words, any suitable type of subcomponents may be incorporated into the cable 100. Examples of suitable types of subcomponents include, but are not limited to, twisted pair, optical fiber, coaxial cable, power conductor, hybrid (e.g., subcomponents that include multiple types of transmission media, etc.) and/or other types of subcomponents. In certain embodiments, all of the subcomponents incorporated into a cable 100 may include similar types of transmission media. In other embodiments, at least two subcomponents may include different types and/or combinations of types of transmission media. For example, the illustrated cable 100 includes a combination of twisted pair 105A-D and optical fiber 105E-G subcomponents. Indeed, a wide variety of suitable combinations of subcomponents may be incorporated into a cable.

In certain embodiments, the cable 100 may include at least two subcomponents that have different cross-sectional areas. For example, a first subcomponent (e.g., a twisted pair subcomponent 105A, etc.) may have a first diameter and/or cross-sectional size or area, and a second subcomponent (e.g., an optical fiber subcomponent 105E, etc.) may have a second diameter and/or cross-sectional size or area that is different than that of the first subcomponent. As set forth above, any number of subcomponents may be incorporated into a cable 100, and these subcomponents may be formed with a wide variety of suitable cross-sectional sizes, cross-sectional areas, and/or dimensions. As explained in greater detail below, the separator 110 may be formed in such a way that it facilitates incorporation of subcomponents having different cross-sectional sizes into the cable 100 while allowing the cable 100 to have a desired overall profile or cross-sectional shape. For example, even though the cable 100 of FIG. 1 includes subcomponents having different cross-sectional sizes, the separator 110 facilitates the overall cable 100 having a round cross-sectional shape or profile.

As shown in FIG. 1, in certain embodiments, the cable 100 may include one or more twisted pair subcomponents 105A-D arranged or positioned around the separator 110. The twisted pair subcomponents 105A-D may extend along a longitudinal direction. In certain embodiments, the twisted pair subcomponents 105A-D and the separator 110 may be helically twisted or stranded together along the longitudinal direction with a wide variety of suitable pitches or twist lays. As shown, each of the twisted pair subcomponents 105A-D may include similar components and/or dimensions. In other embodiments, at least two twisted pair subcomponents may be formed with different components and/or dimensions.

An example twisted pair subcomponent, such as subcomponent 105A, may include a plurality of twisted pairs 120A-D surrounded by one or more suitable outer wraps, such as a shield layer (not shown) and/or a jacket 125. As desired, individual pair shield layers, group shield layers, a separator, and/or other suitable components may be incorporated into the twisted pair subcomponent 105A. Each of these components is described in greater detail below. It will be appreciated that the other twisted pair subcomponents may be formed with similar components as desired.

Any suitable number of twisted pairs 120A-D, such as four pairs, may be incorporated into a twisted pair subcomponent 105A. As desired, the twisted pairs 105A-D may be twisted or bundled together and/or suitable bindings may be wrapped around the twisted pairs 105A-D. In other embodiments, multiple grouping of twisted pairs may be incorporated into a twisted pair subcomponent 105. Each twisted pair (referred to generally as twisted pair 120 or collectively as twisted pairs 120) may include two electrical conductors, each covered with suitable insulation. Each twisted pair 120 can carry data or some other form of information. As desired, each of the twisted pairs may have the same twist lay length or alternatively, at least two of the twisted pairs may include a different twist lay length. A wide variety of suitable twist lay length configurations may be utilized. The electrical conductors of a twisted pair 120 may be formed from any suitable electrically conductive material, such as copper, aluminum, silver, annealed copper, gold, a conductive alloy, etc. Additionally, the electrical conductors may have any suitable diameter, gauge, and/or other dimensions. The twisted pair insulation may include any suitable dielectric materials and/or combination of materials, such as one or more polymeric materials, one or more polyolefins (e.g., polyethylene, polypropylene, etc.), one or more fluoropolymers (e.g., fluorinated ethylene propylene (“FEP”), etc. Insulation may be formed as solid insulation, foamed insulation, or a combination thereof.

In certain embodiments, one or more shield layers may be formed around the twisted pairs 120A-D. For example, an overall shield may be formed around the group of twisted pairs 120A-D, individual shields may be provided for each of the twisted pairs 120A-D, and/or shield layers may be provided for any desired subgroups of the twisted pairs 120A-D. As desired in various embodiments, multiple shield layers and/or types of shield layers may be provided, for example, individual shields and an overall shield. One or more shield layers may incorporate electrically conductive material, semi-conductive material, or dielectric shielding material in order to provide electrical shielding for one or more cable components.

A shield layer may be formed with a wide variety of suitable constructions as desired. For example, a shield layer may be formed as a layer of metallic material or as a metallic foil. As another example, a shield layer may be formed as a braided layer. As yet another example, a shield layer may include any suitable number of dielectric layers and/or shielding layers (e.g., electrically conductive layers, etc.). As desired, a shield layer may be formed as a continuous shield layer along a longitudinal length of the twisted pair subcomponent 105A or, alternatively, a shield layer may be formed as a discontinuous shield layer that includes a plurality of electrically isolated patches of shielding material.

Although the twisted pair subcomponent 105A is illustrated in FIG. 1 as including a jacket 125, in certain embodiments, the twisted pair subcomponent 105A may be formed an unjacketed subcomponent. As such, if shielding layer(s) are incorporated into the twisted pair subcomponent 105A, one or more of the shielding layer(s) may contact the separator 110. Regardless of whether shielding layer(s) are incorporated into the subcomponent 105A, as desired, a suitable binder may be helically wrapped around the plurality of twisted pairs 120A-D or an unjacketed subcomponent 105A in order to hold the internal components together. Additionally, contact between one or more internal components of an unjacketed subcomponent 105A (e.g., one or more shield layers, one or more twisted pairs, etc.) may and the separator 110 may facilitate enhanced cooling of the twisted pairs 120A-D as explained in greater detail below.

In certain embodiments, a suitable separator or filler (not shown) may be incorporated into the twisted pair subcomponent 105A. The separator may be configured to orient and or position one or more of the twisted pairs 120A-D. As desired in various embodiments, the separator may be formed in accordance with a wide variety of suitable dimensions, shapes (e.g., a cross-filler, a flat filler that bisects the twisted pairs, etc.), and/or designs. Any number of suitable materials and/or combinations of materials may be utilized to form a subcomponent separator. For example, any of the materials discussed herein as being suitable for forming the overall separator 110 may also be suitable for forming a twisted pair subcomponent separator.

With continued reference to the twisted pair subcomponent 105A, a jacket 125 may optionally be formed around the internal components of the subcomponent 105A (e.g., the twisted pairs 120A-D, a separator, one or more shield layers, etc.). The jacket 125 may enclose the internal components of the subcomponent 105A, seal the subcomponent 105A from the environment (e.g., when the subcomponent 105A is broken out from the overall cable 100, etc.), and provide strength and structural support. The jacket 125 may be formed from a wide variety of suitable materials, such as a polymeric material, polyvinyl chloride (“PVC”), polyurethane, one or more polymers, a fluoropolymer, polyethylene, medium density polyethylene (“MDPE”), neoprene, chlorosulfonated polyethylene, polyvinylidene fluoride (“PVDF”), polypropylene, modified ethylene-chlorotrifluoroethylene, fluorinated ethylene propylene (“FEP”), ultraviolet resistant PVC, flame retardant PVC, low temperature oil resistant PVC, polyolefin, flame retardant polyurethane, flexible PVC, low smoke zero halogen (“LSZH”) material, plastic, rubber, acrylic, or some other appropriate material known in the art, or a combination of suitable materials. As desired, the jacket 125 may also include flame retardant materials, smoke suppressant materials, carbon black or other suitable material for protection against exposure to ultraviolet (“UV”) light, and/or other suitable additives. The jacket 125 may include a single layer or, alternatively, multiple layers of material (i.e., multiple layers of the same material, multiple layers of different materials, etc.).

Additionally, the jacket 125 and/or the subcomponent 105A may be formed with a wide variety of suitable diameters, cross-sectional sizes, and/or cross-sectional areas. For example, the jacket 125 may be formed with any suitable outer diameter that defines a cross-sectional size or area occupied by the subcomponent 105A. In certain embodiments, the cross-sectional size or area of the subcomponent 105A may be different than that of at least one other subcomponent incorporated into the cable 100.

A wide variety of other components may be incorporated into a twisted pair subcomponent 105A as desired in various embodiments. For example, one or more dielectric separators may be positioned between the conductors of one or more respective twisted pairs. As another example, flame retardant and/or water blocking material may be incorporated into the subcomponent 105A. The subcomponent 105A is illustrated and described by way of non-limiting example only.

With continued reference to FIG. 1, in certain embodiments, the cable 100 may include one or more suitable optical fiber subcomponents 105E-G arranged or positioned around the separator 110 or central member. The optical fiber subcomponents 105E-G may extend along a longitudinal direction. In certain embodiments, the optical fiber subcomponents 105E-G and the separator 110 may be helically twisted or stranded together along the longitudinal direction with a wide variety of suitable pitches or twist lays. As shown, each of the optical fiber subcomponents 105E-G may include similar components and/or dimensions. In other embodiments, at least two optical fiber subcomponents may be formed with different components and/or dimensions.

An example optical fiber subcomponent, such as subcomponent 105E, may include a plurality of buffer tubes 130A-F positioned around a central strength member 135. One or more suitable outer wraps, such as jacket 140, may be formed around the buffer tubes 130A-F. Each of these components is described in greater detail below. It will be appreciated that other optical fiber subcomponents may be formed with similar components as desired. Alternatively, other optical fiber subcomponents incorporated into a cable 100 may be formed with alternative constructions. For example, other optical fiber subcomponents may include different numbers of buffer tubes, optical fibers positioned within microtubes, tight buffered optical fibers, etc. Indeed, a wide variety of different types of optical fiber subcomponents may be utilized as desired.

The central strength member (“CSM”) 135 may provide strength and structural support for the optical fiber subcomponent 105E. For example, the CSM 135 may provide tensile and/or compressive strength and assist in preventing or limiting attenuation within optical fibers positioned within the buffer tubes 130A-F. The CSM 135 may be formed from a wide variety of suitable materials and/or combinations of materials. Examples of suitable materials that may be utilized to form the CSM 135 include, but are not limited to, glass reinforced plastic (“GRP”), fiber reinforced plastic (“FRP”), fiberglass, fiberglass/epoxy composite, strength yarns (e.g., aramid yarns, Spectra® fiber yarns, basalt fiber yarns, ultra-high-molecular weight polyethylene yarns, fiberglass yarns, etc.), and/or a combination thereof (e.g., a combination of strength yarns and a relatively rigid member such as a GRP rod, etc.). The CSM 135 may also be formed with a wide variety of suitable dimensions, such as any suitable diameter, cross-sectional area, cross-sectional shape, etc. An optional coating may also be formed on an outer surface of the CSM 135 to assist in limiting elongation of the buffer tubes 130A-F. Examples of suitable materials that may be utilized to form a coating include, but are not limited to, polyethylene (e.g., medium density polyethylene, etc.), polypropylene, one or more other polymeric materials, one or more thermoplastic materials, one or more elastomeric materials, an ethylene-acrylic acid (“EAA”) copolymer, ethyl vinyl acetate (“EVA”), etc.

With continued reference to the optical fiber subcomponent 105E, a plurality of buffer tubes 130A-F may be positioned around the CSM 135. Although six buffer tubes 130A-F are illustrated in FIG. 1, any other suitable number of buffer tubes may be utilized as desired. As desired, one or more dielectric spacers, fillers, or other components may be utilized in place of one or more of the buffer tube 130A-F. Alternatively, one or more empty buffer tubes may be utilized. In certain embodiments, the buffer tubes 130A-F may be stranded or helically twisted around the CSM 135. In other embodiments, the buffer tubes 130A-F may be S-Z stranded around the CSM 135. Each buffer tube (generally referred to as buffer tube 130) may be configured to contain or house one or more optical fibers. Any number of optical fibers, other transmission elements, and/or other components may be positioned within a buffer tube 130. In certain embodiments, optical fibers may be loosely positioned in a buffer tube 130, wrapped or bundled together, or provided in one or more ribbons or ribbon stacks.

Each buffer tube 130 may be formed with any suitable cross-sectional shapes and/or dimensions, such as any suitable inner and/or outer diameters. A buffer tube 130 may also be formed from any suitable materials or combinations of materials. Examples of suitable materials include, but are not limited to, various polymers or polymeric materials, polyethylene (“PE”), high density polyethylene (“HDPE”), polypropylene (“PP”), acrylate or acrylics (e.g., acrylic elastomers, etc.), polyvinyl chloride (“PVC”), polyurethane, a fluoropolymer, neoprene, polyvinylidene fluoride (“PVDF”), polybutylene terephthalate (“PBT”), ethylene, plastic, or other appropriate materials or combinations of suitable materials. Additionally, a buffer tube 130 may be formed as either a single layer or a multiple layer buffer tube. In the event that multiple layers are utilized, the layers may all be formed from the same material(s) or, alternatively, at least two layers may be formed from different materials or combinations of materials. For example, at least two layers may be formed from different polymeric resins.

Any number of optical fibers may be housed within a buffer tube 130 as desired. Each optical fiber may be a single mode fiber, multi-mode fiber, pure-mode fiber, polarization-maintaining fiber, multi-core fiber, or some other optical waveguide that carries data optically. Additionally, each optical fiber may be configured to carry data at any desired wavelength (e.g., 1310 nm, 1550 nm, etc.) or combination of wavelengths and/or at any desired transmission rate or data rate. The optical fibers may also include any suitable composition and/or may be formed from a wide variety of suitable materials capable of forming an optical transmission media, such as glass, a glassy substance, a silica material, a plastic material, or any other suitable material or combination of materials. Each optical fiber may also have any suitable dimensions. In certain embodiments, an optical fiber may include a core that is surrounded by a cladding. Additionally, one or more suitable coatings may surround the cladding.

In certain embodiments and as shown in FIG. 1, a plurality of optical fibers may be loosely positioned within a buffer tube 130. In other embodiments, a plurality of optical fibers may be arranged into one or more suitable bundles or groupings. As desired, each group of fibers may include one or more suitable wraps or binders that maintains the fibers in a group. For example, a wrap or binder may be helically wrapped around the fibers in a group. Examples of suitable binders include, but are not limited to, identification threads (e.g., a colored thread that facilitates identification of a group of optical fibers, etc.), water-blocking threads, strength yarns, etc. In yet other embodiments, a plurality of optical fibers may be arranged into one or more fiber ribbons and/or into a ribbon stack. For example, optical fibers may be formed or incorporated into a plurality of different ribbon arrangements that are stacked on top of one another to form a ribbon stack. As another example, optical fibers may be formed into one or more ribbon arrangements that are folded or otherwise manipulated into a stacked or other configuration. As yet another example, optical fibers may be arranged in one or more ribbons that each include intermittent, spaced, or spiderweb-type bonding that permits the ribbons to be bundled, rolled, and/or otherwise formed into a desired arrangement.

In certain embodiments, a suitable filling compound may be utilize to fill the buffer tube 130. In other words, a filling compound may be utilized to fill the interstitial spaces within the buffer tube 130 that are not occupied by optical fibers (or other components). In other embodiments, a buffer tube 130 may be formed as a “dry” buffer tube that does not include filling compound. As desired, water-blocking tapes, water-blocking wraps, water-blocking yarns, strength yarns (e.g., aramid yarns), water-blocking powders, moisture absorbing materials, dry inserts, and/or a wide variety of other suitable materials may be incorporated into the buffer tube 130.

With continued reference to the optical fiber subcomponent 105E, a jacket 140 may optionally be formed around the internal components of the subcomponent 105E (e.g., the CSM 135, the buffer tubes 130A-E, etc.). The jacket 140 may enclose the internal components of the subcomponent 105E, seal the subcomponent 105E from the environment (e.g., when the subcomponent 105E is broken out from the overall cable 100, etc.), and provide strength and structural support. The jacket 140 may be formed from a wide variety of suitable materials, such as a polymeric material, polyvinyl chloride (“PVC”), polyurethane, one or more polymers, a fluoropolymer, polyethylene, medium density polyethylene (“MDPE”), neoprene, chlorosulfonated polyethylene, polyvinylidene fluoride (“PVDF”), polypropylene, modified ethylene-chlorotrifluoroethylene, fluorinated ethylene propylene (“FEP”), ultraviolet resistant PVC, flame retardant PVC, low temperature oil resistant PVC, polyolefin, flame retardant polyurethane, flexible PVC, low smoke zero halogen (“LSZH”) material, plastic, rubber, acrylic, or some other appropriate material known in the art, or a combination of suitable materials. As desired, the jacket 140 may also include flame retardant materials, smoke suppressant materials, carbon black or other suitable material for protection against exposure to ultraviolet (“UV”) light, and/or other suitable additives. The jacket 140 may include a single layer or, alternatively, multiple layers of material (i.e., multiple layers of the same material, multiple layers of different materials, etc.).

Additionally, the jacket 140 and/or the subcomponent 105E may be formed with a wide variety of suitable diameters, cross-sectional sizes, and/or cross-sectional areas. For example, the jacket 140 may be formed with any suitable outer diameter that defines a cross-sectional size or area occupied by the subcomponent 105E. In certain embodiments, the cross-sectional size or area of the subcomponent 105E may be different than that of at least one other subcomponent incorporated into the cable 100.

Although the optical fiber subcomponent 105E is illustrated in FIG. 1 as including a jacket 140, in certain embodiments, the subcomponent 105E may be formed an unjacketed subcomponent. Regardless of whether the subcomponent 105E is formed as a jacketed or unjacketed subcomponent, any number of suitable wraps or layers may optionally be formed around or positioned adjacent to the buffer tubes 130A-E. For example, one or more binders may be helically twisted or otherwise wrapped around the buffer tubes 130A-F in order to hold the buffer tubes 110A-F in place. A binder may be formed from a wide variety of suitable materials, such as suitable threads, polymeric tapes, or other materials. As another example, one or more water-blocking layers may be positioned outside of the buffer tubes 130A-F. For example, one or more water-blocking threads or water-blocking tapes may be helically wrapped around the buffer tubes 130A-F or positioned adjacent to the buffer tubes 130A-F. Indeed, a water-blocking layer or component may be formed with a wide variety of suitable constructions (e.g., yarns, tapes, etc.). Additionally, a water-blocking component may include any number of suitable water-blocking materials, such as super absorbent polymers (“SAP”) and/or other suitable materials. As yet another example a strength layer may be formed around the plurality of buffer tubes 130A-F. For example, a layer of strength yarns (e.g., aramid yarns, etc.) may be wrapped or otherwise formed around the plurality of buffer tubes 130A-F.

A wide variety of other components may be incorporated into an optical fiber subcomponent 105E as desired in various embodiments. The subcomponent 105E described above is discussed by way of non-limiting example only. Further, in addition to or as alternative to the twisted pair and optical fiber subcomponents illustrated and described with reference to FIG. 1, a wide variety of other suitable types of cable subcomponents may be incorporated into the cable 100 as desired. For example, coaxial cable, power conductors, and/hybrid subcomponents may be incorporated into a cable. Each subcomponent may include any suitable transmission media and/or other components. Additionally, each subcomponent may be formed as a jacketed or unjacketed subcomponent as desired in various embodiments. Each subcomponent may also be formed with a wide variety of suitable dimensions.

With continued reference to FIG. 1, the separator 110 or central member 110 may be positioned between two or more of the plurality of cable subcomponents 105A-G. The separator 110 may be formed as a longitudinally extending member or divider that assists in maintaining the positions of any number of the subcomponents 105A-G. In accordance with an aspect of the disclosure, the separator 110 may assist in or facilitate the cable 100 be formed with a desired overall cross-sectional shape. For example, even though subcomponents having different cross-sectional sizes and/or cross-sectional areas are incorporated into the cable 100, the separator 110 may facilitate the cable 100 being formed with an overall round or circular cross-sectional shape. In other embodiments, the separator 110 may facilitate the cable 100 having a wide variety of other suitable cross-sectional shapes, such as an elliptical cross-sectional shape.

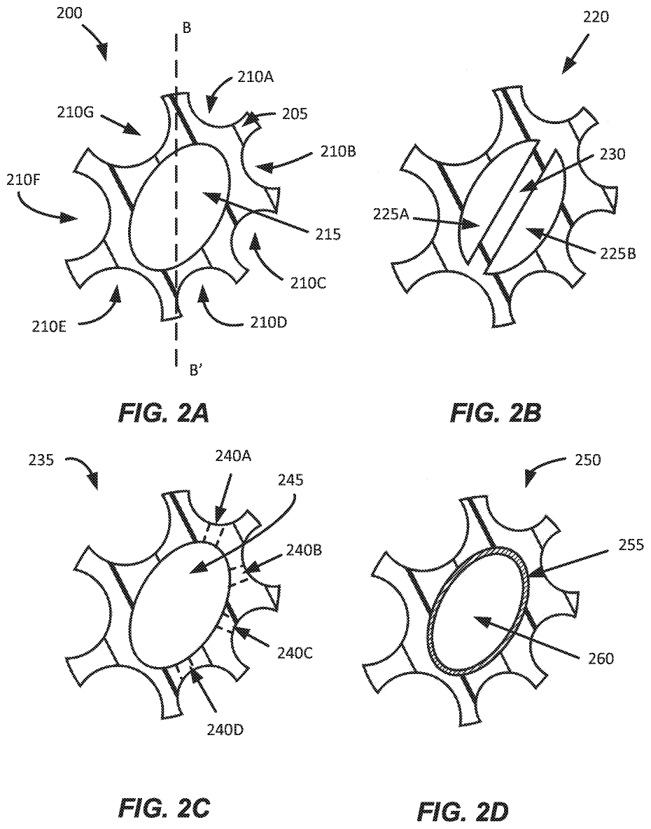

The separator 110 may be formed with a wide variety of suitable dimensions, cross-sectional shapes, and/or designs as desired in various embodiments. In certain embodiments, the separator 110 may be formed with an asymmetrical cross-sectional shape. In other words, the separator 110 may have a shape or body portion that is asymmetrical along a line extending perpendicular to a longitudinally extending direction and that bisects the cable 100 and/or the separator 110. With reference to FIG. 1, line A-A′ may bisect the cable 100 in a cross-sectional direction that is perpendicular to the longitudinal direction of the separator 110 and/or the cable 100. Portions of the separator 110 positioned on opposite sides of the line A-A′ may be asymmetrical to one another. An example line that bisects a separator is illustrated and described in greater detail below with reference to FIG. 2A. In certain embodiments, as a line is drawn at different positions such that it bisects the separator 110 or cable 100, the separator 110 may still have an asymmetrical cross-sectional shape. In other words, the line A-A′ illustrated in FIG. 1 is provided by way of example only and a wide variety of other suitable cross-sectional lines may be formed that bisect the cable 100 and/or the separator 110.

In certain embodiments, an outer surface or outer periphery of the separator 110 may define a plurality of channels 145A-G into which the one or more of the plurality of cable subcomponents 105A-G are positioned. For example, a respective channel may be defined or provided for each of the subcomponents 105A-G. As shown in FIG. 1, a first channel 145A may be defined for the first subcomponent 105A; a second channel 145B may be defined for the second subcomponent 105B; a third channel 145C may be defined for the third subcomponent 105C; a fourth channel 145D may be defined for the fourth subcomponent 105D; a fifth channel 145E may be defined for the fifth subcomponent 105E; a sixth channel 145F may be defined for the sixth subcomponent 105F; and seventh channel 145G may be defined for the seventh subcomponent 105G.

Although the separator 110 of FIG. 1 is illustrated as including seven channels 145A-G, any suitable number of channels may be formed or defined on an outer surface of the separator 110 as desired in various embodiments. In various embodiments, a separator 110 may include or define 2, 3, 4, 5, 6, 7, 8, 9, 10, 11, 12, or any other suitable number of channel, a number of channels included in a range between any two of the numbers above (e.g., between 2 and 10 channels, etc.), or a number of channels included in a range bounded on a minimum or maximum end by one of the numbers above.

A channel (generally described as channel 145) may be formed with any suitable cross-sectional shapes, cross-sectional areas, and/or other dimensions. In certain embodiments, one or more channels may be sized in order to accommodate the respective subcomponents positioned within the one or more channels. For example, with reference to FIG. 1, the first channel 145A may be sized to facilitate positioning of the first subcomponent 105A within the first channel 145A; the second channel 145B may be sized to facilitate positioning of the second subcomponent 105B within the second channel 145B; and so on. Additionally, in certain embodiments and as illustrated in FIG. 1, one or more subcomponents 105A-G may partially fit within respective channels 145A-G. In other words, when a subcomponent is positioned within a channel, the channel may not extend beyond an opposite or distal side or portion of the subcomponent. In other embodiments, one or more subcomponents may completely fit within one or more respective channels. In other words, a channel 145 may include portions (e.g., sides, prongs, extensions, etc.) that extend from a body of the separator 110 at least a distance corresponding to a diameter or other appropriate dimension of a subcomponent 105 positioned within the channel 145.

Additionally, in certain embodiments (e.g., embodiments in which a channel 145 does not extend beyond a subcomponent 105, embodiments in which a channel 145 has an open face or side, etc.), a channel 145 may work in conjunction with the outer jacket 115 or other cable component (e.g., a wrap formed around the subcomponents 105A-G) to enclose a subcomponent 105. In other embodiments, a channel 145 may partially or completely enclose a subcomponent 105. For example, when a subcomponent 105 is positioned within a channel 145, the channel 145 may include one or more extensions or projections that extend at least partially around a distal side or portion of the subcomponent 105 in order to partially or completely enclose the subcomponent 105.

In certain embodiments, at least two of the plurality of channels 145A-G may have cross-sectional areas or sizes that are different from one another. In other words, a first channel included in the plurality of channels 145A-G (e.g., channel 145A) may be formed with a first cross-sectional area or size, and a second channel included in the plurality of channels 145A-G (e.g., channel 145E) may be formed with a second cross-sectional area or size that is different than the first cross-sectional area or size. As shown in FIG. 1, the channels 145A-D that accommodate the twisted pair subcomponents 105A-D may have different cross-sectional areas or cross-sectional sizes than the channels 145E-G that accommodate the optical fiber subcomponents 105E-G. In other words, the respective channels 145A-G may be sized in accordance with the outer diameters and/or other dimensions of the subcomponents 105A-G positioned within the channels 145A-G. Any number of channels may be formed along an outer surface or periphery of the separator 110, and the various channels may each have a wide variety of suitable dimensions. Indeed, any suitable combination of channels may be formed in order to accommodate various combinations and sizes of subcomponents. In certain embodiments, the incorporation of channels having different cross-sectional areas or sizes may result in or contribute to the separator 110 having an asymmetrical cross-sectional shape.

As illustrated in FIG. 1, in certain embodiments, one or more of the plurality of channels 145A-G may be formed with cross-sectional shapes that correspond to the subcomponents 105A-G positioned within the channels 145A-G. For example, one or more channels 145A-G may be formed as concave channels or as channels having a concave cross-sectional shape. In this regard, the channels 145A-G may accommodate the positioning of subcomponents having rounded cross-sectional shapes, such as circular or elliptical subcomponents. Channels 145A-G may be formed with a wide variety of other suitable cross-sectional shapes as desired in order to accommodate the positioning of different types and/or shapes of subcomponents within the channels 145A-G.

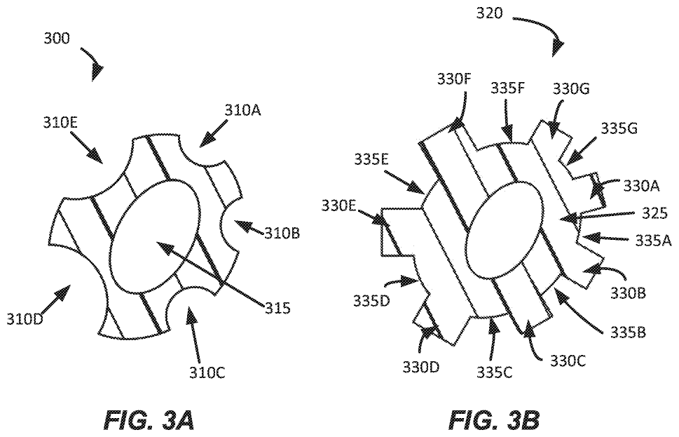

In other embodiments, and as illustrated and described in greater detail below with reference to FIG. 3B, the separator 110 may include a central or body portion positioned between the plurality of subcomponents 105A-G and one or more extensions, prongs, fins, or spokes may extend from the body portion. For example, prongs may extend from a central body portion having an asymmetrical cross-sectional shape. As desired, any number of prongs or extensions may extend from the body portion. Additionally, each prong or extension may extend between two of the subcomponents 105A-G or other suitable components positioned adjacent to the separator 110. Further, prongs may be formed with a wide variety of suitable materials, dimensions, constructions, and/or arrangements.

A wide variety of suitable methods or techniques may be utilized as desired in order to form a separator 110. In certain embodiments, material may be extruded through one or more dies and/or via any number of other suitable extrusion techniques in order to obtain a desired cross-sectional shape. In other embodiments, material may be cast or molded into a desired shape to form the separator 110. Additionally, in certain embodiments, a separator 110 may be formed in a single pass (e.g., a single extrusion step). In other embodiments, a separator 110 may be formed via multi-step process. For example, a separator 110 may be formed with a plurality of layers. As another example, various components of the separator 110 (e.g., a body portion, fins or extensions, etc.) may be formed separately and then combined together. As desired, different manufacturing techniques may be utilized to form various components.

As a result of a separator 110 including an asymmetrical cross-sectional shape and/or a separator 110 defining at least two channels having different cross-sectional sizes, the separator 110 may facilitate the formation of a cable 100 that includes at least two subcomponents having different cross-sectional sizes while the cable 100 also has a desired overall cross-sectional shape or profile. For example, a plurality of cable subcomponents 105A-G having different cross-sectional sizes may be positioned into corresponding channels 145A-G having different cross-sectional sizes and that are defined by an outer periphery of a separator 110. In certain embodiments, the separator channels 145A-G may position the cable subcomponents 105A-G such that the cable 100 includes a round or circular cross-sectional shape or profile.

With continued reference to FIG. 1, in certain embodiments, at least one longitudinal cavity 150 may extend along a longitudinal length of the separator 110, for example, from a first end of the separator 110 to a distal end of the separator 110 along the longitudinal direction. Additionally, in certain embodiments, a longitudinal cavity 150 may extend through a body portion of the separator 110. Accordingly, the separator 110 may have both one or more inner surfaces that define respective cavities and an outer surface that defines an outer periphery of the separator 110. The at least one longitudinal cavity 150 may reduce an amount of material incorporated into the separator 110 and/or reduce a weight of the separator 110 and/or the cable 100.

In certain embodiments, the longitudinal cavity 150 may also facilitate convective heat transfer along a longitudinal length of the separator 110 and/or cable 100. For example, as heat is generated in the cable 100 (e.g., heat in twisted pair subcomponents 105A-D, heat in power subcomponents, heat developed at a portion of the cable 100 situated near electronic equipment, etc.), the longitudinal cavity 150 may facilitate transfer of the heat to other portions of the cable 100. In other words, the longitudinal cavity 135 may promote temperature balancing within the cable 100, thereby cooling the relatively hotter portions of the cable 100. As a result of this convective heat transfer, the electrical performance of the cable 100 and/or electronic equipment associated with the cable 100 may be improved or enhanced. In certain embodiments, such as embodiments in which the cable 100 or certain subcomponents are used for delivering power signals, the convective heat transfer may facilitate increased power transmission rates.

The separator 110 illustrated in FIG. 1 has a single longitudinal cavity 150. In other embodiments, a separator 110 may be formed with a plurality of longitudinal cavities. An example separator that includes a plurality of longitudinal cavities is illustrated and described in greater detail below with reference to FIG. 2B. Any suitable number of longitudinal cavities may be incorporated into a separator 110 as desired. In the event that a plurality of longitudinal cavities are utilized, in certain embodiments, each of the longitudinal cavities may have similar dimensions (e.g., diameters, cross-sectional shapes, etc.). In other embodiments, at least two longitudinal cavities may have different dimensions. Additionally, as desired, any number of internal ribs, dividers, spokes, or other suitable portions may separate the longitudinal cavities from one another and provide internal support for the separator 110.

A wide variety of suitable methods or techniques may be utilized to form a longitudinal cavity 150 as desired. In certain embodiments, the separator 110 may be extruded in a manner that facilitates the formation of one or more longitudinal cavities. For example, an extrusion die utilized to form the separator 110 may also facilitate the formation of one or more longitudinal cavities. A longitudinal cavity 150 may also be formed with a wide variety of suitable dimensions and/or cross-sectional shapes. In certain embodiments, a longitudinal cavity 150 may be formed with an asymmetrical cross-sectional shape with respect to a line that bisects or divides the longitudinal cavity 150 in a cross-sectional direction perpendicular to a longitudinal length. A longitudinal cavity 150 may also have any suitable cross-sectional area. For example, the longitudinal cavity 150 may have a cross-sectional area of approximately 0.8 mm², 1.0 mm², 1.5 mm², 2 mm², 3 mm², 4 mm², 5 mm², 6 mm², 7 mm², 8 mm², 9 mm², 10 mm², 11 mm², 12 mm², 13 mm², 14 mm², 15 mm², 16 mm², 17 mm², 18 mm², 19 mm², 20 mm², 21 mm², 22 mm², 23 mm², 24 mm², 25 mm², a value incorporated in a range between any two of the above values, or a value incorporated in a range bounded on a minimum or maximum end by one of the above values. Additionally, in certain embodiments, the longitudinal cavity 150 (or the combination of a plurality of longitudinal cavities) may be sized in order to achieve a desired convective heat transfer rate along the cable 100.

In certain embodiments, the longitudinal cavity 150 may be filled with a suitable gas, such as air, nitrogen, helium, or a suitable mixture of gases. As desired, a gas or mixture of gases having a desired thermal conductivity, such as a thermal conductivity estimated using the Chapman-Enskog model, may be selected. In other embodiments, the longitudinal cavity 150 may be filled with a suitable refrigerant or cooling liquid, such as water, glycols, one or more dielectric fluids, etc. Additionally, in certain embodiments, a substance (e.g., air, etc.) may be permitted to freely migrate within the channel. In other embodiments, the cable 100 may be connected to one or more suitable circulation systems that facilitate flow of a cooling substance through the cable 100. For example, one or more fans may be positioned at an end of the cable 100 to facilitate gas flow through the longitudinal cavity 150. As another example, one or more suitable pumping systems, compressors, refrigeration systems, etc. may facilitate the flow of cooling gas and/or liquid through the longitudinal cavity 150. In the event that a plurality of longitudinal cavities are incorporated into a separator, in certain embodiments, one or more fluid diverting end caps and/or other suitable components may be utilized to facilitate the recirculation of fluids (e.g., gases, liquids, etc.) through two or more longitudinal cavities. In other embodiments, one or more transmission media and/or other components may be positioned with a longitudinal cavity 150. For example, one or more optical fibers, twisted pairs, conductors, water swellable elements, shielding elements, etc. may be positioned within a longitudinal cavity 150.

In certain embodiments, the separator 110 may additionally include one or more second cavities that extend from a longitudinal cavity 135 through the separator 110. For example, one or more second cavities may extend from a surface of a longitudinal cavity 150 through a body of the separator 110 to an outer surface of the separator 110. An example separator that includes second cavities is illustrated and described in greater detail below with reference to FIG. 2C. The second cavities may further facilitate convective heat transfer via the separator 110. For example, one or more second cavities may facilitate transfer of heat from other areas of the cable core (e.g., areas in which one or more twisted pairs subcomponents 105A-D are positioned) to the longitudinal cavity 150, and the longitudinal cavity 150 may then assist in normalizing the temperature of the cable 100 along its longitudinal length.

A second cavity may be formed with a wide variety of suitable dimensions. As desired in various embodiments, a second cavity may have an approximately circular, elliptical, square, rectangular, hexagonal, octagonal, or any other suitable cross-sectional shape. Additionally, the second cavity may have any suitable cross-sectional diameter and/or other dimensions (e.g., width, area, etc.) that define the size of the second cavity. In certain embodiments, the second cavity may be sized in order to achieve a desired convective heat transfer rate between the cable core and the longitudinal cavity 150. Any number of second cavities may be incorporated into the separator 110. Additionally, a wide variety of configurations and/or arrangements of second cavities may be utilized. In certain embodiments, one or more second cavities may be positioned at a plurality of respective points along the longitudinal length of the separator 110. For example, second cavities may be spaced along the separator 110 in a pattern or with a repeating step. A wide variety of suitable spacings or distances may be present between second cavities. In other embodiments, second cavities may be positioned along the separator 110 in accordance with a random or pseudo-random pattern.

Additionally, in certain embodiments, a single second cavity may be formed at each respective cross-sectional location along a longitudinal length of the separator 110. In other embodiments, a plurality of second cavities may be formed at one or more locations at which second cavities are positioned. For example, a first one of the second cavities may open at a first point along an outer periphery of the separator 110 (e.g., a location proximate to a first subcomponent) while a second one of the second cavities may open at a second point along an outer periphery of the separator 110 (e.g., a location proximate to a second subcomponent). Any number of second cavities may be formed at a given location.

A wide variety of suitable methods or techniques may be utilized to form one or more second cavities as desired in various embodiments. In certain embodiments, after the separator 110 is formed (e.g., extruded, etc.), one or more suitable punching, cutting, and/or drilling devices may be utilized to form second cavities in the separator 110. Each device may form respective second cavities at a plurality of locations along the separator 110 as the separator 110 is fed past and/or through the device. In certain embodiments, the separator 110 may be extruded or otherwise formed, and second cavities may then be formed in a relatively continuous or on-line process. In other embodiments, formation of the separator 110 and the second cavities may occur in an off-line manner.

As desired in various embodiments, electromagnetic shielding material may be incorporated into the separator 110. A wide variety of different types of materials may be utilized to provide shielding, such as electrically conductive material, semi-conductive material, and/or dielectric shielding material. In certain embodiments, one or more electrically conductive materials may be utilized including, but not limited to, metallic material (e.g., silver, copper, nickel, steel, iron, annealed copper, gold, aluminum, etc.), metallic alloys, conductive composite materials, etc. Indeed, suitable electrically conductive materials may include any material having an electrical resistivity of less than approximately 1×10⁻⁷ ohm meters at approximately 20° C. In certain embodiments, an electrically conductive material may have an electrical resistivity of less than approximately 3×10⁻⁸ ohm meters at approximately 20° C. In other embodiments, one or more semi-conductive materials may be utilized including, but not limited to, silicon, germanium, other elemental semiconductors, compound semiconductors, materials embedded with conductive particles, etc. In yet other embodiments, one or more dielectric shielding materials may be utilized including, but not limited to, barium ferrite, etc.

Additionally, as desired, shielding material may be incorporated into the separator 110 at a wide variety of locations. In certain embodiments, shielding material may be formed on one or more surfaces of the separator 110. For example, shielding material may be formed on an internal surface of the separator 110 body within the longitudinal cavity 150. As another example, shielding material may be formed on an external surface of the separator 110, such as on an external surface of a separator 110 body, within one or more of the channels 145A-D, and/or on one or more fins, prongs, or extensions. As yet another example, shielding material may be formed on a plurality of surfaces of the separator 110, such as on an internal surface and on an external surface. In other embodiments, shielding material may be embedded within the body of the separator 110. For example, particles of shielding material may be blended into or otherwise incorporated into the body of the separator 110. As another example, a layer of shielding material may be positioned between layers of a separator 110 body, such as two dielectric layers. In yet other embodiments, a separator 110 may be extruded, molded, or otherwise formed from a one or more suitable shielding materials. In yet other embodiments, a separator 110 may include a plurality of different types of shielding materials. For example, a separator 110 may be extruded from a dielectric shielding material and one or more layers of electrically conductive material may be formed on the separator 110. A wide variety of other suitable separator constructions that incorporate shielding material may also be utilized.

In certain embodiments, the separator 110 may include shielding material that is continuous along the longitudinal length of the separator 110. For example, a relatively continuous layer of shielding material may be formed on a separator surface. As another example, the separator 110 may be formed from one or more shielding materials. In other embodiments, the separator 110 may include discontinuous shielding material. With discontinuous shielding material, shielding material may be spaced throughout the separator 110 or within a layer of the separator 110 (e.g., a layer formed on a surface) and gaps or spaces may be present between adjacent shielding material components. In certain embodiments, one or more discontinuous patches of shielding material may be formed. For example, discontinuous patches of shielding material may be formed on one or more separator surfaces. A wide variety of suitable configurations and/or patterns of discontinuous shielding material may be formed as desired in various embodiments.

As set forth above, in certain embodiments, one or more prongs, extensions, fins, or projections (hereinafter referred to as prongs) may be incorporated into a separator 110. For example, one or more prongs may extend from a central or body portion of the separator 110 between various subcomponents. Each prong may have a wide variety of suitable dimensions and/or constructions. A prong may also be formed from a wide variety of suitable materials and/or combination of materials. In certain embodiments, a prong may be formed from the same material or groups of materials as a body portion of the separator 110. For example, a separator 110 may be molded or extruded to include both a body portion and one or more prongs. In other embodiments, a prong may be formed from a different material or group of materials than a body portion of the separator 110. For example, a body portion of the separator 110 may be formed from one or more polymeric materials, and a prong may be formed from an electrically conductive material or from a dielectric material that includes electrically conductive patches. In this regard, the prong may provide shielding between two subcomponents (e.g., two twisted pair subcomponents, etc.) and/or may function as a heat sink that draws heat away from the subcomponents and transfers it to the separator 110.

Additionally, in certain embodiments, a prong may be continuous along a longitudinal length of the separator 110. In other words, the prong may extend approximately from one end of the separator 110 to a distal end of the separator 110. In other embodiments, a prong may selectively extend from the separator 110 at various locations along its longitudinal length. For example, one meter sections of prongs may extend from the separator 110 with gaps or spaces formed between adjacent sections. Each prong section may have any suitable longitudinal length, and the gaps or spaces between sections may have any suitable longitudinal lengths. In certain embodiments, the various prong sections may be formed in accordance with a repeating pattern or definite step. In other embodiments, prong sections may be formed with random or pseudo-random longitudinal lengths. In yet other embodiments, different longitudinally-extending sections of a prong, regardless of whether the prong is continuous or whether it includes gaps between a plurality of sections, may be formed from different materials and/or groups of materials. For example, a first section may be formed from an electrically conductive material while a second section is formed from a dielectric material. As another example, a first section may be formed from a dielectric material while a second section is formed from a flame retardant material. Indeed, a wide variety of suitable combinations of materials may be utilized.

As desired in various embodiments, one or more heat sinks may also be incorporated into the separator 110. A heat sink may operate to absorb and/or transfer thermal energy or heat away from one or more subcomponents 105A-G and/or electronic equipment associated with the cable 100. In certain embodiments, a heat sink may transfer heat to the longitudinal cavity 150 such that the heat may be removed and/or dissipated. A wide variety of different types of heat sinks may be incorporated into the separator 110. Examples of suitable heat sinks include heat sinks formed from aluminum, aluminum alloys, copper, copper alloys, other metallic materials, diamond, one or more composite materials, etc. Additionally, a heat sink may be positioned at a wide variety of locations within a separator 110. In certain embodiments, a heat sink may be positioned within a longitudinal cavity 150 or within a second cavity. In other embodiments, a heat sink may extend partially or completely through the separator body, for example, from the longitudinal cavity 150 through the separator body to an external surface. In yet other embodiments, one or more prongs or various portions of one or more channels 145A-G may be formed or partially formed from or as heat sinks. A heat sink may be formed with a wide variety of suitable dimensions as desire, such as with a wide variety of suitable shapes (e.g., rectangular, trapezoidal, etc.) and/or sizes. Additionally, a plurality of heat sinks may be arranged into any suitable configuration, such as a pin fin configuration, a straight fin configuration, or a flared fin configuration. Further, as desired in various embodiments, heat sinks may be positioned at a wide variety of suitable locations along a longitudinal length of the separator 110. In other embodiments, a heat sink may be relatively continuous along a longitudinal length of the separator 110.

In certain embodiments, a separator 110 may be formed from a single segment or portion. In other words, the separator 110 may be formed as a relatively continuous separator along a longitudinal length of the cable 100. In other embodiments, a separator 110 may be formed from a plurality of discrete or severed segments or portions. For example, discrete segments or portions may be positioned adjacent to one another along a longitudinal length of the separator 110. In certain embodiments, gaps or spaces may be present between various segments or portions of the separator 110. In other embodiments, at least a portion of the segments may be arranged immediately adjacent to one another or in an overlapping configuration.

The separator 110 may be formed from a wide variety of suitable materials and/or combinations of materials desired in various embodiments. For example, the separator 110 and/or various portions of the separator 110 can include paper, metals, alloys, various plastics, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, one or more dielectric shielding materials (e.g., barium ferrite, etc.) or any other suitable material or combination of materials. As desired, the separator 110 may be filled, unfilled, foamed, un-foamed, homogeneous, or inhomogeneous and may or may not include additives (e.g., flame retardant and/or smoke suppressant materials).

With continued reference to the cable 100 of FIG. 1, the jacket 115 may enclose the internal components of the cable 100, seal the cable 100 from the environment, and provide strength and structural support. The jacket 115 may be formed from a wide variety of suitable materials and/or combinations of materials, such as one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or a combination of any of the above materials. The jacket 115 may be formed as a single layer or, alternatively, as multiple layers. In certain embodiments, the jacket 115 may be formed from one or more layers of foamed material. As desired, the jacket 115 can include flame retardant and/or smoke suppressant materials. Additionally, the jacket 115 may include a wide variety of suitable shapes and/or dimensions. For example, the jacket 115 may be formed to result in a round cable or a cable having an approximately circular cross-section; however, the jacket 115 and internal components may be formed to result in other desired shapes, such as an elliptical, oval, or rectangular shape. The jacket 115 may also have a wide variety of dimensions, such as any suitable or desirable outer diameter and/or any suitable or desirable wall thickness. In various embodiments, the jacket 115 can be characterized as an outer jacket, an outer sheath, a casing, a circumferential cover, or a shell.

An opening enclosed by the jacket 115 may be referred to as a cable core, and the separator 110 and subcomponents 105A-G may be disposed within the cable core. Although a single cable core is illustrated in FIG. 1, a cable may be formed to include multiple cable cores. In certain embodiments, a cable core may be filled with a gas such as air (as illustrated) or alternatively a gel, solid, powder, moisture absorbing material, water-swellable substance, dry filling compound, or foam material, for example in interstitial spaces between the internal components. Other elements can be added to the cable core as desired, for example one or more optical fibers, additional electrical conductors, additional twisted pairs, water absorbing materials, and/or strength members, depending upon application goals.

As desired in various embodiments, a wide variety of other materials may be incorporated into the cable 100. For example, as set forth above, the cable 100 may include any number of subcomponents, conductors, twisted pairs, optical fibers, and/or other transmission media. As another example, the cable 100 may include a suitable armor layer, such as a corrugated armor or dielectric armor layer. Additionally, as desired, a cable may include a wide variety of strength members, swellable materials (e.g., aramid yarns, blown swellable fibers, etc.), insulating materials, dielectric materials, flame retardants, flame suppressants or extinguishants, gels, and/or other materials. The cable 100 illustrated in FIG. 1 is provided by way of example only. Embodiments of the disclosure contemplate a wide variety of other cables and cable constructions. These other cables may include more or less components than the cable 100 illustrated in FIG. 1. Additionally, certain components may have different dimensions and/or materials than the components illustrated in FIG. 1.

Example Separator Constructions

As set forth above, a separator, such as the separator 110 illustrated in FIG. 1, may be formed with a wide variety of suitable constructions, cross-sectional shapes, and/or dimensions. FIGS. 2A-2D are cross-sectional views of example separators that may be formed as variations of the separator 110 illustrated in FIG. 1. FIGS. 3A-3B are cross-sectional views of alternative example separators that may be utilized in other embodiments. Each of these example separators is described in greater detail below.

Turning first to FIG. 2A, a first example separator 200 is illustrated. The separator 200 may include components that are similar to those discussed above with reference to the separator 110 of FIG. 1. For example, the separator 200 may be formed as a longitudinally extending member that facilitates positioning and/or separation of any number of cable subcomponents. Additionally, the separator 200 may be formed with or include a body portion 205 that is formed with an asymmetrical cross-sectional shape with respect to a line B-B′ that bisects the separator in a cross-sectional direction that is perpendicular to a longitudinal direction of the separator 200.

The separator 200 may also include a plurality of channels 210A-G defined along an outer surface or outer periphery of the separator 200. As desired, any number of cable subcomponents may be positioned within the channels 210A-G. Any number of channels may be defined by the separator 200, and each channel may be formed with a wide variety of suitable cross-sectional shapes and/or sizes. In certain embodiments, at least two of the channels may be formed with different cross-sectional sizes. In other words, a first channel may be formed with a first cross-sectional size, and a second channel may be formed with a second cross-sectional size different than the first cross-sectional size.

With continued reference to FIG. 2A, in certain embodiments, at least one longitudinally extending cavity 215 may extend along a longitudinal length of the separator 200, for example, from a first end of the separator 200 to a distal end of the separator 200 along the longitudinal direction. The longitudinal cavity 215 may be formed with a wide variety of suitable cross-sectional shapes, cross-sectional areas, and/or other suitable dimensions. In certain embodiments, the longitudinal cavity 215 may be formed with a asymmetrical cross-sectional shape, such as an asymmetrical cross-sectional shape with respect to line B-B′. The at least one longitudinal cavity 215 may reduce an amount of material incorporated into the separator 200 and/or reduce a weight of the separator 200. In certain embodiments, the longitudinal cavity 215 may also facilitate convective heat transfer along a longitudinal length of the separator 200. As desired, any number of components (e.g., optical fibers, transmission media, etc.) may be positioned within the longitudinal cavity.

FIG. 2B illustrates a second example separator 220 that may be utilized in various embodiments. The separator 220 may include components similar to those of the separators 110, 200 discussed above with reference to FIGS. 1 and 2A; however, the separator 220 is illustrated as including a plurality of longitudinal cavities 225A, 225B formed through a body portion of the separator 220. Any suitable number of longitudinal cavities may be incorporated into a separator 220 as desired in various embodiments. In certain embodiments, each of a plurality of longitudinal cavities may have similar dimensions (e.g., diameters, cross-sectional shapes, etc.). In other embodiments, at least two longitudinal cavities may have different dimensions. Additionally, as desired, any number of internal ribs, dividers, spokes, or other suitable portions may separate various longitudinal cavities from one another and provide internal support for the separator 220. For example, a divider or spoke 230 may be formed between the two longitudinal cavities 225A, 225B incorporated into the separator 220.

FIG. 2C illustrates a third example separator 235 that may be utilized in various embodiments. The separator 235 may include components similar to those of the separators 110, 200 discussed above with reference to FIGS. 1 and 2A; however, the separator 235 is illustrated as including one or more second cavities 240A-D that extend from a longitudinally extending cavity 245 through a body portion of the separator 235 and to an outer surface of the separator 235. As set forth in greater detail above with reference to FIG. 1, any number of second cavities may be incorporated into a separator 235 as desired. Additionally, the second cavities 240A-D may be positioned at a wide variety of suitable locations along an outer periphery and/or a longitudinal length of the separator 235. In FIG. 2C, respective second cavities 240A-D may extend from the longitudinal cavity 245 to channels defined along an outer periphery of the separator 235 in which one or more twisted pair subcomponents (or other subcomponents including conductive elements) may be positioned. In this regard, the second cavities 240A-D may facilitate additional cooling via convective heat transfer.

FIG. 2D illustrates a fourth example separator 250 that may be utilized in various embodiments. The separator 250 may include components similar to those of the separators 110, 200 discussed above with reference to FIGS. 1 and 2A; however, the separator 250 is illustrated as additionally including shielding material 255. As set forth in greater detail above, shielding material may be incorporated into a separator 250 at a wide variety of suitable locations. For example, as shown in FIG. 2D, shielding material 260 may be formed or positioned on a surface of a longitudinally extending channel 260 formed through the separator 250. In other embodiments, shielding material may be formed on an outer surface of a separator 250 (e.g., within one or more channels defined by an outer surface of the separator 250, etc.), embedded within the separator 250, or incorporated at a wide variety of other suitable locations. In yet other embodiments, a separator 250 may be formed from shielding material.

The separators 200, 220, 235, 250 of FIGS. 2A-2D are illustrated as variations to the separator 110 illustrated in FIG. 1. Additionally, the separators 200, 220, 235, 250 illustrate optional features that may be incorporated into a separator having an asymmetrical cross-sectional shape. As desired, any number of the features illustrated in FIGS. 2A-2D may be selectively combined together within a separator. In other embodiments, a wide variety of different types of separators may be utilized as alternatives to the separators illustrated and discussed above with reference to FIGS. 1-2D. These alternative separators may be formed with a wide variety of suitable cross-sectional shapes, dimensions, and/or features. A few non-limiting examples of alternative separator designs are illustrated in FIGS. 3A and 3B.

FIG. 3A illustrates an example separator 300 that includes a body portion 305 and a plurality of channels 310A-E formed on an outer periphery or by an outer surface of the body portion 305. Additionally, one or more longitudinally extending cavities 315 may be formed through the body portion 305. Each of the components of the separator 300 may be similar to the corresponding components of the separator 110 described above with reference to FIG. 1. However, while the separator 110 of FIG. 1 illustrates seven channels 145A-G defined by an outer surface of the separator 110, the separator 300 of FIG. 3A illustrates five channels 310A-E. Any number of suitable channels may be defined by or incorporated into a separator as desired in various embodiments. Additionally, each channel may be sized accordingly in order to facilitate the positioning of a desired subcomponent within the channel.

FIG. 3B illustrates another example separator 320 that may be utilized as an alternative to the separator 110 illustrated and described above with respect to FIG. 1. While the separator 110 illustrates a plurality of concave channels 145A-G that are defined along or by an outer periphery of the separator 110, the separator 320 of FIG. 3B is illustrated as including a body portion 325 and a plurality of prongs 330A-G or extensions that extend from the body portion 325 in order to define a plurality of channels 335A-G into which cable subcomponents may be positioned. Each prong (generally referred to as prong 330) may extend between two cable subcomponents or other cable components. In certain embodiments, two prongs may define each channel. For example, a first prong 330A and a second prong 330B may define a first channel 335A; the second prong 330B and a third prong 330C may define a second channel 335B; and so on. Any number of suitable prongs may be incorporated into a separator 320 as desired. Additionally, a prong 330 may be formed with a wide variety of suitable dimensions.

A wide variety of other suitable separators may be utilized as desired in other embodiments. These separators may include any suitable shapes and/or dimensions. Additionally, separators may include any of the features and/or combination of features described and illustrated above with respect to FIGS. 1-3B. The separators discussed herein are provided by way of non-limiting example only.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cable comprising:
a separator extending along a longitudinal direction, the separator comprising:
a unitary body portion having an asymmetrical cross-sectional shape taken along a line extending perpendicular to the longitudinal direction that bisects the cable, wherein an outer periphery of the body portion defines a plurality of longitudinally extending channels comprising a first channel having a first cross-sectional area and a second channel having a second cross-sectional area different than the first cross-sectional area; and
at least one cavity extending through the body portion along the longitudinal direction; and
a first cable subcomponent positioned within the first channel, the first cable subcomponent having a third cross-sectional area and comprising first transmission media;
a second cable subcomponent positioned within the second channel, the second cable subcomponent having a fourth cross-sectional area different from the third cross-sectional area and comprising second transmission media; and
a jacket formed around the separator, the first cable subcomponent, and the second cable subcomponent.

2. The cable of claim 1, wherein at least one of the plurality of channels comprises a concave cross-sectional shape.

3. The cable of claim 1, wherein the plurality of channels comprises between two and ten channels.

4. The cable of claim 1, wherein the at least one cavity comprises a plurality of cavities extending parallel to one another along the longitudinal direction.

5. The cable of claim 1, wherein the cable comprises a round cross-sectional shape.

6. The cable of claim 1, wherein the separator further comprises electromagnetic shielding material.

7. A cable comprising:
a separator extending along a longitudinal direction, the separator comprising:
a unitary body portion comprising an outer periphery defining a plurality of longitudinally extending channels into which cable subcomponents are disposed, the plurality of longitudinally extending channels comprising a first channel having a first cross-sectional size and a second channel having a second cross-sectional size different than the first cross-sectional size; and
at least one cavity extending through the body portion along the longitudinal direction; and
a first cable subcomponent positioned within the first channel, the first cable subcomponent comprising first transmission media and having a third cross-sectional size corresponding to the first cross-sectional size;
a second cable component positioned within the second channel, the second cable subcomponent comprising second transmission media and having a fourth cross-sectional size corresponding to the second cross-sectional size and different from the third cross-sectional size; and
a jacket formed around the separator, the first cable subcomponent, and the second cable subcomponent.

8. The cable of claim 7, wherein the body portion comprises a cross-sectional shape that is asymmetrical along a line that is perpendicular to the longitudinal direction and that bisects the cable.

9. The cable of claim 7, wherein at least one of the plurality of channels comprises a concave cross-sectional shape.

10. The cable of claim 7, wherein the plurality of channels comprises between two and ten channels.

11. The cable of claim 7, wherein the at least one cavity comprises a plurality of cavities extending parallel to one another along the longitudinal direction.

12. The cable of claim 7, wherein the cable comprises a round cross-sectional shape.

13. The cable of claim 7, wherein the separator further comprises electromagnetic shielding material.

14. A cable comprising:
a separator extending along a longitudinal direction, the separator comprising:
a unitary body portion having an asymmetrical cross-sectional shape taken along a line extending perpendicular to the longitudinal direction that bisects the cable, wherein an outer periphery of the body portion defines a plurality of longitudinally extending channels into which cable subcomponents are disposed; and
at least one cavity extending through the body portion along the longitudinal direction; and
a first cable subcomponent positioned within a first of the plurality of channels, the first cable subcomponent having a first cross-sectional size;
a second cable subcomponent positioned with a second of the plurality of channels, the second cable subcomponent having a second cross-sectional size; and
a jacket formed around the separator, the first cable subcomponent, and the second cable subcomponent, wherein the jacket provides the cable with a round cross-sectional shape.

15. The cable of claim 14, wherein the plurality of longitudinally extending channels comprises:
a first channel having a first cross-sectional size; and
a second channel having a second cross-sectional size different than the first cross-sectional size.

16. The cable of claim 14, wherein at least one of the plurality of channels comprises a concave cross-sectional shape.

17. The cable of claim 14, wherein the plurality of channels comprises between two and ten channels.

18. The cable of claim 14, wherein the at least one cavity comprises a plurality of cavities extending parallel to one another along the longitudinal direction.

19. (canceled)

20. The cable of claim 14, wherein the separator further comprises electromagnetic shielding material.
